(19) United States
(12) Patent Application Publication
(10) Pub. No.: US 2026/0235349 A1
(43) Pub. Date: Aug. 13, 2026

(54) SOLID-CRYOGEN ENCAPSULATION SYSTEM

(71) Applicant: The United States of America, as represented by the Secretary of the Navy, Arlington, VA (US)

(72) Inventors: Anna M. Leese, Encinitas, CA (US); JAMES J. COLLINS, Hampstead, NC (US)

(21) Appl. No.: 19/051,717

(22) Filed: Feb. 12, 2025

(51) Int. Cl. F25J 1/00

(52) U.S. Cl. CPC F25J 1/0015; B29C 33/0022; B29C 33/10; B29C 33/12

(57) ABSTRACT

A solid-cryogen encapsulation system includes a cryogen source, a container, and a cooling system. The container is coupled to receive liquid cryogen supplied by the cryogen source. The container includes a freezing compartment, a cover, and a conduit. The freezing compartment has an opening through which a mold structure is temporarily received. The mold structure includes a device suspended within an interior cavity of the mold structure. The cover is configured to selectively close the opening and seal the freezing compartment, where the conduit is within the freezing compartment and fills the interior cavity of the mold structure with the liquid cryogen to submerge the device. The cooling system is coupled to the container to freeze the liquid cryogen within the interior cavity of the mold structure to encapsulate the device in a solid cryogen.

### FEDERALLY-SPONSORED RESEARCH AND DEVELOPMENT

The United States Government has ownership rights in one or more inventions provided in this disclosure. Licensing inquiries may be directed to Office of Research and Technical Applications, Naval Information Warfare Center Pacific, Code 72110, San Diego, CA, 92152; (619) 553-5118; NIWC_Pacific_T2@us.navy.mil.Reference Navy Case No. 112521.

### TECHNICAL FIELD

Aspects of the present disclosure relate generally to cryogenic systems, and in particular but not exclusively, relate to a portable system for generating a solid cryogen with a device encapsulated within.

### BACKGROUND OF THE INVENTION

Cryogenic temperatures are often taken to be temperatures below −150° C. Cryogenic temperatures can cause significant changes to the properties of materials, such as their strength, ductility, thermal conductivity, or electrical resistance/conductivity, among other things.

Thus, some devices may have improved or unique performance abilities when kept at these cryogenic temperatures. For instance, the device may be an electronic device, such as a superconductor, a high speed processor, a low-noise amplifier, or an antenna or sensor array, just to name a few, that all could have improved performance when operated at cryogenic temperatures. In other examples, the device may be a platform carrying a biological material that exhibits certain preferred characteristics when cooled to such low temperatures.

Various techniques exist to cool these devices to desired cryogenic temperatures. For instance, the device may be incorporated into an active cooling system. One example of an active cooling system is a cryocooler that uses refrigeration cycles to achieve cryogenic temperatures. The cryocooler may include mechanisms (e.g., pumps, condensers, etc.) that cool and continuously circulate coolants across or near the device.

In other examples, a substance, referred to as a cryogen, may be utilized to absorb heat from the device, cooling the device down to a cryogenic temperature. Examples of common cryogens are liquid nitrogen, hydrogen, oxygen, or helium.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example solid-cryogen encapsulation system, in accordance with aspects of the present disclosure.

FIG. 2 illustrates an example cryogen source, in accordance with aspects of the present disclosure.

FIG. 3 illustrates an example cooling system, in accordance with aspects of the present disclosure.

FIG. 4 illustrates an example container, in accordance with aspects of the present disclosure.

FIGS. 5A and 5B illustrate an example mold structure, in accordance with aspects of the present disclosure.

FIGS. 5C and 5D illustrate example mold structures having a device mount, in accordance with aspects of the present disclosure.

FIG. 5E illustrates an example mold structure having a fill sensor, in accordance with aspects of the present disclosure.

FIGS. 5F and 5G illustrate an example mold structure having a wire port, in accordance with aspects of the present disclosure.

FIG. 6A illustrates an example mold structure having a plurality of interior cavities and a channel, in accordance with aspects of the present disclosure.

FIG. 6B illustrates an example mold structure having a plurality of inlet ports, in accordance with aspects of the present disclosure.

FIG. 7A illustrates an example solid-cryogen encapsulated device, in accordance with aspects of the present disclosure.

FIG. 7B illustrates an example solid-cryogen encapsulated device having wires, in accordance with aspects of the present disclosure.

FIG. 7C illustrates an example solid-cryogen encapsulated device having a device mount, in accordance with aspects of the present disclosure.

FIGS. 7D and 7E illustrate an example solid-cryogen encapsulated device having a device mount configured to route wires of the device, in accordance with aspects of the present disclosure.

FIG. 8A illustrates an example solid-cryogen encapsulated device having a capsule shape, in accordance with aspects of the present disclosure.

FIG. 8B illustrates an example solid-cryogen encapsulated device having a peanut shape, in accordance with aspects of the present disclosure.

FIG. 9 illustrates an example controller for use with a solid-cryogen encapsulation system, in accordance with aspects of the present disclosure.

FIG. 10 is a flow-chart illustrating a method of generating a solid-cryogen encapsulated device, in accordance with aspects of the present disclosure.

### DETAILED DESCRIPTION

Embodiments of a solid-cryogen encapsulation system, a mold structure, a method, and a solid-cryogen encapsulated device are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As mentioned above, certain devices may be cooled to cryogenic temperatures to achieve preferred performance and/or characteristics. However, challenges exist in maintaining the device at the desired temperature for extended periods of time outside of any laboratory environment. For example, incorporating an active cooling system with the device may increase the size, complexity, and power requirements for operating the device in a deployed environment. In addition, running the active cooling system may interfere with the operation of the device itself. For example, in some instances, the device may include one or more highly-sensitive superconductor electronics that are configured for active radio frequency (RF) detection. In this example, an active cooling system may generate vibrations and/or noise that prevents or, at least, interferes with the RF detection.

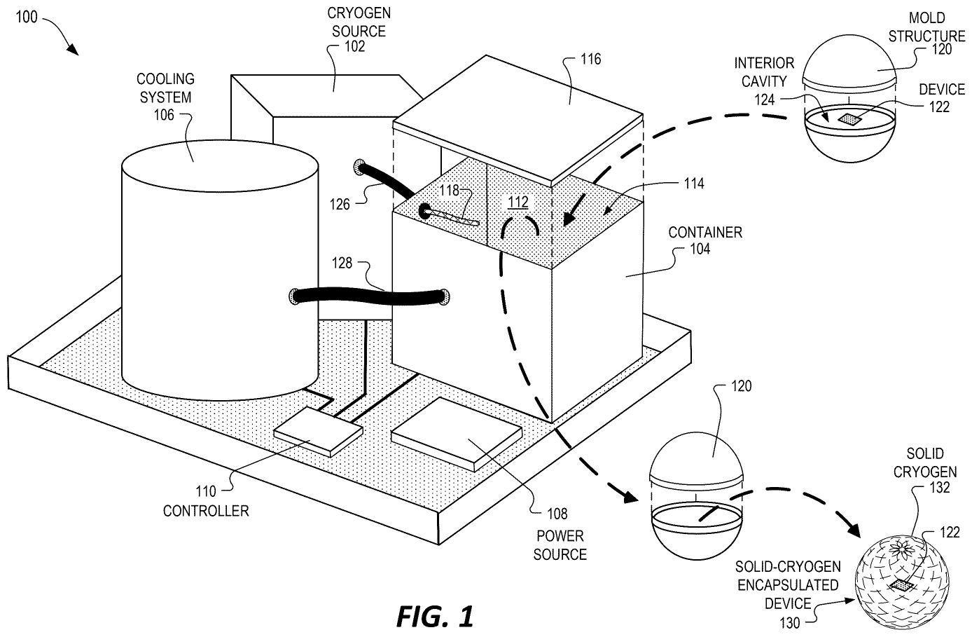

Accordingly, aspects of the present disclosure provide a system for repeatedly creating portable solid cryogen environments for the passive (and quiet) cooling of a device for sustained periods of time. For example, FIG. 1 illustrates a solid-cryogen encapsulation system 100, in accordance with aspects of the present disclosure. System 100 is shown as including a cryogen source 102, a container 104, a cooling system 106, a power source 108, and an optional controller 110. Container 104 is shown as including a freezing compartment 112, an opening 114, a cover 116, and a conduit 118. Also shown in FIG. 1 is an example mold structure 120 that includes a device 122 suspended within an interior cavity 124 of the mold structure 120.

In some examples, the cryogen source 102, the container 104, and the cooling system 106 are integrated together into a single portable system that allows for the repeated generation of a solid-cryogen encapsulated device 130 in a field-deployable environment. In some examples, the power source 108 may be a self-contained power source, such as a battery or a solar power generator.

In operation, a user may provide a mold structure 120 that includes a device 122 suspended within the interior cavity 124 of the mold structure 120. The user places the mold structure 120 within freezing compartment 112 of container 104 and the freezing compartment 112 is then closed and sealed via cover 116. System 100 then fills the interior cavity 124 of the mold structure 120 with a liquid cryogen via a conduit 118 to submerge the device 122 while the mold structure 120 remains within the freezing compartment 112. The cooling system 106 then freezes the liquid cryogen that is within the interior cavity 124 to encapsulate the device 122 in a solid cryogen 132. The user may then open the cover 116, remove the mold structure 120 from the freezing compartment 112, and optionally remove the solid-cryogen encapsulated device 130 from the mold structure 120 to use as intended. That is, solid-cryogen encapsulated device 130 may then be combined with a device platform (not shown) that utilizes device 122 while device 122 is cooled to a cryogenic temperature (i.e., by way of being embedded within solid cryogen 132). For example, as mentioned above, device 122 may include high temperature superconductor electronics for active frequency signal detection. Thus, the solid-cryogen encapsulated device 130 may be removed from the freezing compartment 112 and then connected to a device platform and/or housing that includes additional circuitry and components required for such signal detection.

Once, the solid cryogen 132 melts and/or once a temperature of the device 122 is no longer at the target cryogenic temperature, the device 122 and its associated mold structure 120 may be returned to the freezing compartment 112 to regenerate the solid-cryogen encapsulated device 130. In some examples, one or more additional solid-cryogen encapsulated devices 130 may be formed and stored within the freezing compartment 112 until needed to ensure continued operation of the device platform.

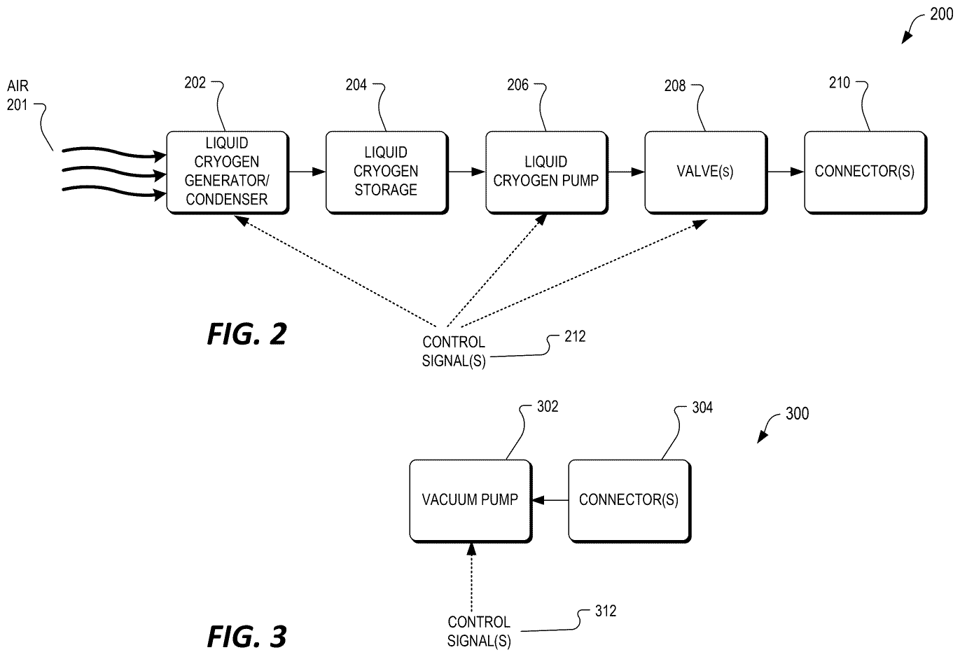

Turning now to the particular structure shown in FIG. 1, cryogen source 102 is coupled to the container 104 via one or more connectors 126. Connectors 126 may include solid and/or flexible tubing, piping, etc. for transferring liquid cryogen supplied by the cryogen source 102 to the container 104. In some examples, cryogen source 102 includes a refillable reservoir of liquid cryogen and a pump for transferring the liquid cryogen out of the reservoir through the connectors 126. In another example, cryogen source 102 is configured to generate a continuous supply of the liquid cryogen extracted from the ambient air. For instance, FIG. 2 illustrates an example cryogen source 200, in accordance with aspects of the present disclosure. Cryogen source 200 is one possible implementation of cryogen source 102 of FIG. 1. Cryogen source 200 is shown as including a liquid cryogen generator/condenser 202, a liquid cryogen storage 204, a liquid cryogen pump 206, one or more valves 208, and one or more connectors 210.

Liquid cryogen generator/condenser 202 is configured to extract a cryogen from ambient air 201 to produce a liquid cryogen. In some examples, the cryogen is nitrogen extracted from ambient air 201, which is then condensed by a condenser into a liquid nitrogen (LN2). Various methods or techniques may be utilized by the liquid cryogen generator/condenser 202 to produce the liquid cryogen. For example, liquid cryogen generator/condenser 202 may utilize a liquefaction cycle that cools gases until they liquefy. In another example, liquid cryogen generator/condenser 202 may utilize a distillation process that includes cooling the ambient air 201 until it turns into a liquid and then distilling the liquid to separate cryogenic liquids (e.g., oxygen, nitrogen, etc.).

The liquid cryogen storage 204 is coupled to the liquid cryogen generator/condenser 202 to receive and store the liquid cryogen produced. In some examples, the liquid cryogen storage 204 is an insulated container, such as a Dewar, configured to maintain the liquid cryogen in a liquid state. The liquid cryogen pump 206 is coupled to the liquid cryogen storage 204 to transfer the liquid cryogen from the liquid cryogen storage 204 to the container 104 via connectors 210 (e.g., corresponding to connector 124 of FIG. 1). Cryogen source 200 is also shown as including one or more valves 208. The one or more valves 208 are coupled between the liquid cryogen pump 206 and the container 104 to control the flow of liquid cryogen. In some examples, the one or more valves 208 are incorporated into the connectors 210. As will be described in more detail below, the one or more valves 208 may include an inline check-valve and an optional inline flow meter.

In some implementations, operation of one or more of the liquid cryogen generator/condenser 202, the liquid cryogen pump 206, and the one or more valves 208 are under control of one or more control signals 212, generated by a controller such as controller 110 of FIG. 1.

Returning now to FIG. 1, cooling system 106 is shown as coupled to the container 104 via one or more connectors 128. Connectors 128 may include solid and/or flexible tubing, piping, etc. for enabling cooling system 106 to cool the freezing compartment 112. In some examples, cooling system 106 is configured to freeze the liquid cryogen that is within the interior cavity 124 of the mold structure 120, while the mold structure 120 is within the freezing compartment 112.

FIG. 3 illustrates an example cooling system 300, in accordance with aspects of the present disclosure. Cooling system 300 is one possible implementation of cooling system 106 of FIG. 1. Cooling system 300 is shown as including a vacuum pump 302 and one or more connectors 304. In some implementations, operation of the vacuum pump 302 is under control of one or more control signals 312, generated by a controller such as controller 110 of FIG. 1.

The vacuum pump 302 is coupled to the container 104 via connectors 304 (e.g., corresponding to connectors 128 of FIG. 1) to evacuate the freezing compartment 112 to a vacuum or a near vacuum. For instance, vacuum pump 302 may be configured to evacuate the freezing compartment 112 to a pressure level of 0.1 atmospheres or less. In one example, vacuum pump 302 is a high volume (e.g., 6 to 10 Cubic Feet per Minute (CFM)) vacuum pump.

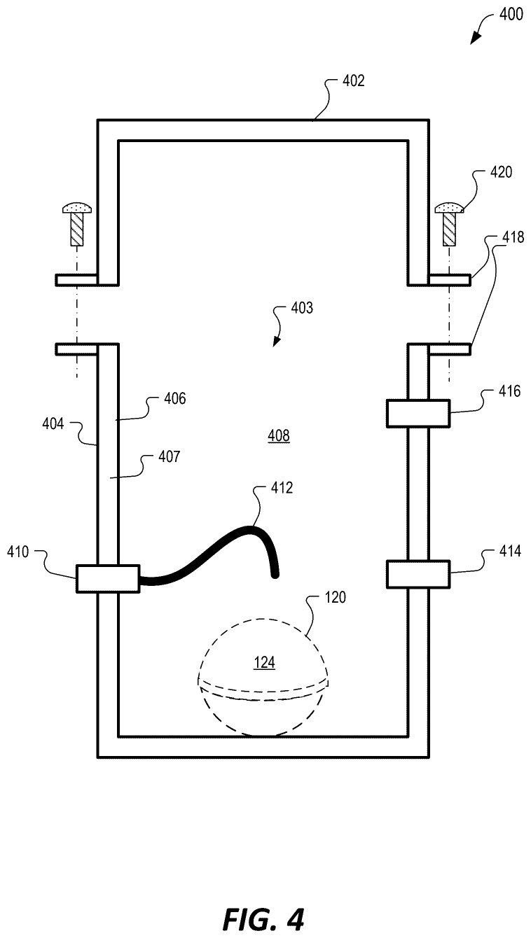

As described above with reference to FIG. 1, a mold structure 120 is placed into the freezing compartment 112 through the opening 114 where the cover 116 is then used to close the opening 114 to seal the freezing compartment 112 of container 104. The cryogen source 102 may then fill the interior cavity 124 with the liquid cryogen to submerge the device 122 where cooling system 106 then freezes the liquid cryogen into a solid cryogen, all while the mold structure 120 is within the freezing compartment 112 of container 104. In some aspects, container 104 is an insulated container configured to minimize or at least reduce thermal transfer through the walls of the container 104, itself. For example, FIG. 4 illustrates an example container 400, in accordance with aspects of the present disclosure. Container 400 is one possible implementation of container 104 of FIG. 1.

Container 400 is shown as including a cover 402, an opening 403, an exterior wall 404, an interior wall 406, an insulated region 407, a freezing compartment 408, a connector 410, a conduit 412, a connector 414, an optional pressure relief valve 416, an optional flange 418, and optional bolts 420.

As shown in FIG. 4, container 400 includes an opening 403 through which a mold structure 120 is temporarily received within the freezing compartment 408. Cover 402 is configured to selectively close the opening 403 and seal the freezing compartment 408 while the mold structure 120 is housed within. Although FIG. 4 illustrates cover 402 as a lid, in other examples, cover 402 may be a door, a drawer, a hatch, a panel, or any other access means for selectively providing an opening into the freezing compartment 408 that is large enough to accommodate the mold structure 120. Also shown in FIG. 4 are one or more flanges 418. Flanges 418 are configured for selectively securing the cover 402 to close and seal the opening 403. FIG. 4 illustrates flanges 418 selectively secured with one or more bolts 420. However, in other examples, flanges 418 may be selectively secured with one or more other securing means, such as a clamp, a screw, an interlocking mechanism, a strap, a magnet, etc.

FIG. 4 also illustrates interior wall 406 as being separated from exterior wall 404 by the insulated region 407. That is, the insulated region 407 is between the interior wall 406 and the exterior wall 404 to prevent or at least reduce the transfer of thermal energy from outside the container 400 to within the freezing compartment 408. In one example, insulated region 407 is a vacuum or near-vacuum insulated region. In some examples, both the interior wall 406 and the exterior wall 404 are formed from a metal with a vacuum insulated region 407 between the metal walls. In another example, the interior wall 406 is formed from an insulating material such as glass, ceramics, or plastic.

Connector 410 is configured to couple to an external connector to receive liquid cryogen (e.g., coupled to connector 126 of FIG. 1) and to pass the liquid cryogen though the walls 404/406 of the container 400. As shown, conduit 412 is coupled to the interior wall 406 (e.g., coupled to the connector 410 within the freezing compartment 408). Conduit 412 may be a hose or a pipe that is configured to selectively connect to the mold structure 120. In operation, when connected to the mold structure 120, the conduit 412 transfers the liquid cryogen received at the connector 410 to the mold structure 120 to fill the interior cavity 124 of the mold structure 120. In other examples, conduit 412 is a spout that is configured to dispense the liquid cryogen into a channel, opening, or other liquid cryogen receiving means of the mold structure 120.

Connector 414 is configured to couple to an external connector to enable to evacuation of the freezing compartment 408 to a vacuum or near vacuum. For example, connector 414 may be coupled to connector 128 of FIG. 1.

As mentioned above, in some examples, container 400 is configured to maintain and store one or more solid-cryogen encapsulated devices 130. Thus, cover 402 may be configured to maintain the seal on the freezing compartment 408 such that the vacuum level is kept for an extended period of time. Also, the insulated region 407 is configured to maintain the temperature within the freezing compartment 408 for an extended period of time. However, eventually, at least some of the solid cryogen may begin to melt, causing a build-up of gas. Thus, in some implementations, container 400 includes an optional pressure relief valve 416 to outgas this pressure build up that may occur during such melting of the solid cryogen. In some aspects, pressure relief valve 416 is a one-way check valve built into the walls 404/406 of the container 400.

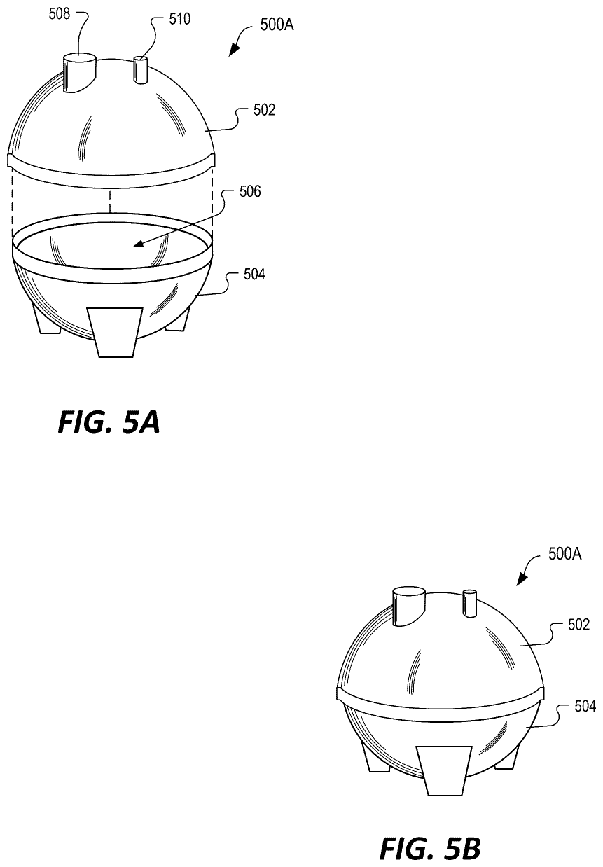

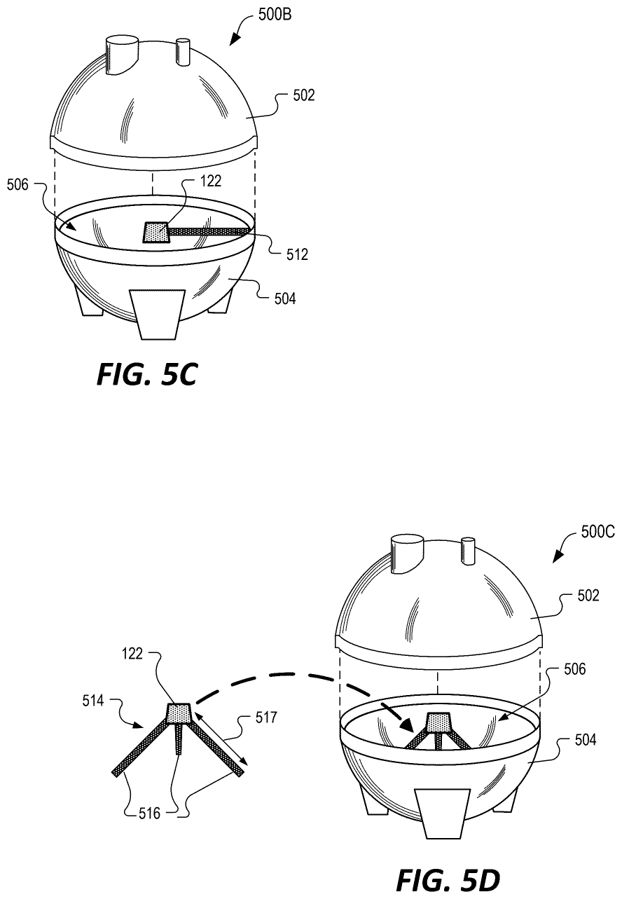

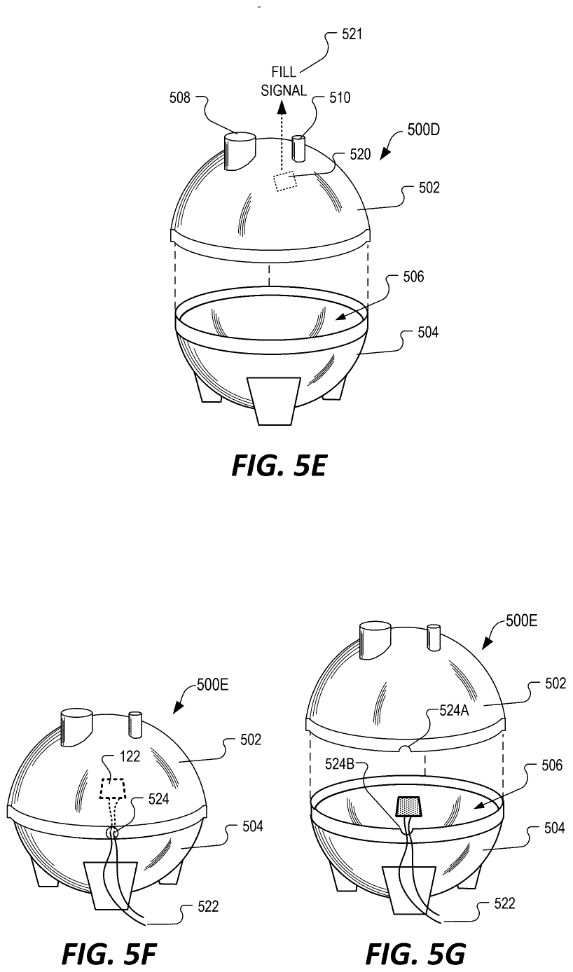

FIGS. 5A and 5B illustrate an example mold structure 500A for use with a solid-cryogen encapsulation system, in accordance with aspects of the present disclosure. Mold structure 500A is one possible implementation of mold structure 120 of FIG. 1. The illustrated example of mold structure 500A is shown as including a first die 502, a second die 504, an interior cavity 506, an inlet port 508, and an outlet port 510. In some aspects, the mold structure 500A, including the first die 502, the second die 504, and the interior cavity 506 are formed from a metal. In other examples, the mold structure 500A is formed from a ceramic material.

When mated together (e.g., as shown in FIG. 5B), the first die 502 and the second die 504 define the interior cavity 506 of the mold structure 500A. When the interior cavity 506 is filled with liquid cryogen which is then frozen into a solid cryogen, the solid cryogen will have a size and shape that conforms to that of the interior cavity 506. That is, the interior cavity 506 defines a shape of the eventual solid cryogen. The illustrated example of interior cavity 506 is shown as defining a spherical shape. In other examples, interior cavity 506 may any other 3D shape, such as a cubic, a pyramidal, or other regular or irregular 3D shape. However, in some implementations, having hard edges present in the shape of the interior cavity 506 may result in voids/empty spaces in the resultant solid cryogen due to the formation of bubbles in those areas as the liquid cryogen freezes. Accordingly, in some aspects the interior cavity 506 defines a continuously-curved shape that is absent any edges (e.g., spherical, capsule-shaped, donut-shaped, ellipsoid-shaped, etc.) to prevent, or at least minimize the formation of bubbles during the freezing process.

The inlet port 508 is shown in FIGS. 5A and 5B as being disposed on the first die 502. However, in other examples, inlet port 508 may be disposed on the second die 504. The inlet port 508 is configured to receive the liquid cryogen from the conduit (e.g., conduit 118 of FIG. 1 and/or conduit 412 of FIG. 4) and to direct the liquid cryogen into the interior cavity 506. Similarly, the outlet port 510 is shown as being disposed on the first die 502, but may alternatively be disposed on the second die 504. The outlet port 510 is configured to vent cryogen gas as at least some of the liquid cryogen evaporates during the freezing of the liquid cryogen into solid cryogen.

FIG. 5C illustrates an example mold structure 500B having a device mount 512, in accordance with aspects of the present disclosure. Mold structure 500B is one possible implementation of mold structure 120 of FIG. 1. As shown in FIG. 5C, device mount 512 is disposed within the interior cavity 506 and is configured to receive and suspend the device 122 within the interior cavity 506. In some examples, device mount 512 is configured to suspend the device 122 at or near a center point of the shape defined by the interior cavity 506. Having the device 122 at or near the center point may increase the consistency of temperatures experienced by the device 122 once it is encapsulated within the solid cryogen.

As shown in FIG. 5C, device mount 512 is coupled to the second die 504. However, in other examples, device mount 512 is coupled to the first die 502. In some implementations, device mount 512 is removably coupled to one of the dies 502/504. For example, the device mount 512 may be connected to the second die 504 to suspend the device 122 while the interior cavity 506 is filled with the liquid cryogen. Then, once the liquid cryogen is frozen into solid cryogen, the device mount 512 may be decoupled from the second die 504 to enable the solid-cryogen encapsulated device (e.g., 130 of FIG. 1) to be removed from the mold structure 500B. In some aspects, the device mount 512 may be removably coupled to the second die 504 by way of a breakaway joint, a temporary adhesive, a magnet, an interlocking structure, etc.

In some examples, device mount 512 is constructed from a material that is configured to dissolve in response to the freezing of the liquid cryogen such that after freezing, the device 122 is left suspended within the solid cryogen without the device mount 512 present. For example, the device mount 512 may be formed from a material that liquefies and/or dissolves at a temperature that is lower than the liquid cryogen that surrounds the device mount 512.

FIG. 5D illustrates an example mold structure 500C having a freestanding device mount 514, in accordance with aspects of the present disclosure. Mold structure 500C is one possible implementation of mold structure 120 of FIG. 1. As shown, device mount 514 is a freestanding device mount that is neither coupled to the first die 502 nor to the second die 504. Instead, freestanding device mount 514 is configured to be placed within the interior cavity 506 to rest on an interior of the second die 504. In some implementations, freestanding device mount 514 includes one or more legs 516. In the illustrated example, legs 516 are arranged as a tri-pod. In some aspects, each leg 516 has a length 517 that is configured such that when placed within the second die 504, suspends the device 122 at or near a center of the interior cavity 506.

As will be described in more detail below, in some examples, generating solid-cryogen encapsulated devices (e.g., device 130 of FIG. 1) may be automated, or at least under the control of one or more controllers, such as controller 110. Thus, in some implementations, mold structures described herein may include one or more built-in sensors and/or mechanisms indicating whether the interior cavity of the mold structure is full of the liquid cryogen. For example, FIG. 5E illustrates a mold structure 500D having a fill sensor 520 disposed on the first die 502, in accordance with aspects of the present disclosure. Mold structure 500D is one possible implementation of mold structure 120 of FIG. 1. In some aspects, fill sensor 520 is configured to generate one or more fill signals 521 indicating that the interior cavity 506 of the mold structure 500D is full of the liquid cryogen. In some aspects, fill sensor 520 includes a fill gauge, such as a ball fill or float gauge. In other aspects, fill sensor 520 includes a temperature sensor (e.g., thermocouple) indicating the presence of liquid cryogen. In yet another aspect, fill sensor 520 includes a capacitance sensor configured to utilize the dielectric properties of the liquid cryogen for detection. Fill sensor 520 may be configured to transmit the fill signals 521 wirelessly through the walls of the container (e.g., container 104 of FIG. 1), through an RF window optionally included in the container, and/or by way of one or more wires routed though the walls of the container to a controller (e.g., controller 110 of FIG. 1).

As mentioned above, in some aspects, the device 122 is an electronic device that, after encapsulation, is to be connected/incorporated into a device platform. Thus, in some examples, the device 122 includes one or more wires. Such wires may include power, ground, data, leads, or other communication wires, that will need to be accessible after encapsulation of the device 122 within the solid cryogen. Accordingly, in some aspects the mold structures as provided herein may include one or more wire ports for allowing the pass-through of wires from the device 122. For example, FIG. 5F illustrate an example mold structure 500E having a wire port 524, in accordance with aspects of the present disclosure. As shown in FIGS. 5F and 5G, the device 122 includes one or more wires 522. Wire port 524 is configured to, while the device 122 is suspended in the interior cavity 506, pass the one or more wires 522 from the interior cavity 506 to an exterior of the mold structure 500E. In some examples, wire port 524 is a hole in one of the first die 502 or the second die 504 that is large enough to pass through the wires 522, yet small enough to contain the liquid cryogen. In some examples, wire port 524 may include a grommet or other gasket for containing the liquid cryogen within the mold structure 500E. In yet another example, shown in FIG. 5G, both the first die 502 and the second die 504 include respective notches 524A and 524B that together form the wire port 524.

The illustrated examples of mold structures 500A-500E illustrate single stand-alone mold structures, each having a single interior cavity 506. In some examples, multiple mold structures 500A-500E may be placed into a solid-cryogen encapsulation system depending on the size of the freezing compartment of the container (e.g., freezing compartment 112 of container 104 of FIG. 1), such that multiple solid-cryogen encapsulated devices 130 may be simultaneously generated. In other examples, a mold structure may be provided as described below that includes multiple interior cavities for simultaneously generating multiple solid-cryogen encapsulated devices 130 with a single structure.

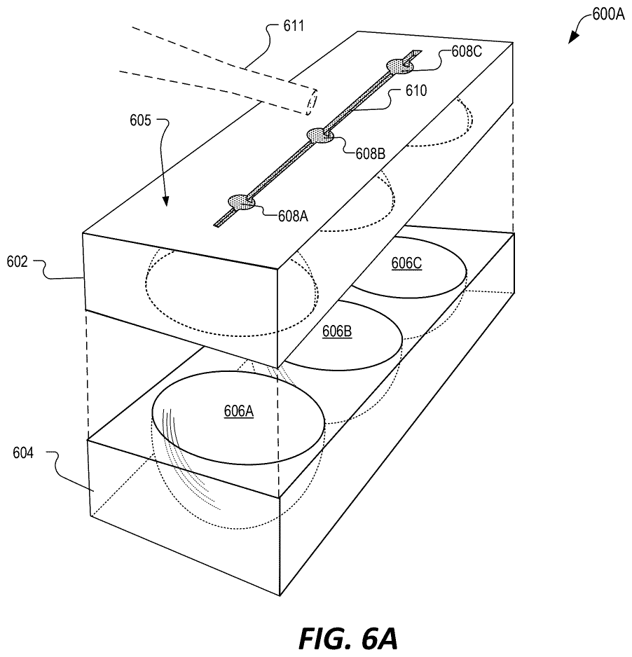

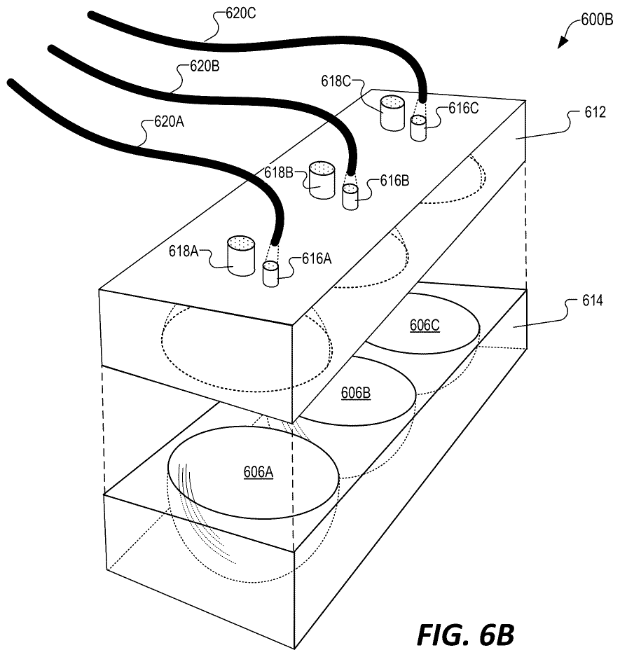

For example, FIG. 6A illustrates a mold structure 600A having a plurality of interior cavities 606A-606C and a channel 610, in accordance with aspects of the present disclosure. Mold structure 600A is also shown as including a first die 602, a second die 604, and inlet ports 608A-608C. Also shown in FIG. 6A is a spout 611, which in some implementations corresponds to conduit 118 of FIG. 1. Mold structure 600A is one possible implementation of mold structure 120 of FIG. 1.

When mated together, the first die 602 and the second die 604, together define a plurality of interior cavities 606A-606C, each configured to receive and suspend a respective device (e.g., device 122). FIG. 6A further illustrates the first die 602 as including a channel 610 that is embedded onto an exterior surface 605 (e.g., topmost surface) of the first die 602. In some aspects, channel 610 is a groove configured to receive and direct liquid cryogen to each of the inlet ports 608A-608C and into respective interior cavities 606A-606C. As mentioned above, spout 611 is one possible implementation of conduit 118, and is positioned to dispense the liquid cryogen into the channel 610 for disbursement among the interior cavities 606A-606C.

FIG. 6B illustrates another example mold structure 600B having a plurality of interior cavities 606A-606C, in accordance with aspects of the present disclosure. Mold structure 600B is shown as including first die 612, a second die 614, inlet ports 616A-616C, and outlet ports 618A-618C. Also shown in FIG. 6B are conduits 620A-620C, which in some implementations collectively correspond to conduit 118 of FIG. 1. Mold structure 600B is one possible implementation of mold structure 120 of FIG. 1.

When mated together, the first die 612 and the second die 614, together define a plurality of interior cavities 606A-606C, each configured to receive and suspend a respective device (e.g., device 122). FIG. 6B further illustrates the first die 612 as including inlet ports 616A-616C and outlet ports 618A-618C. In some aspects, each inlet port 616A-616C is configured to connect to a respective one of the conduits 620A-620C to receive and direct liquid cryogen into a respective interior cavity 606A-606C. Outlet ports 618A-618C are positioned and configured to outgas any cryogen gas that may be generated by the liquid cryogen in a respective interior cavity 606A-606C as the liquid cryogen freezes.

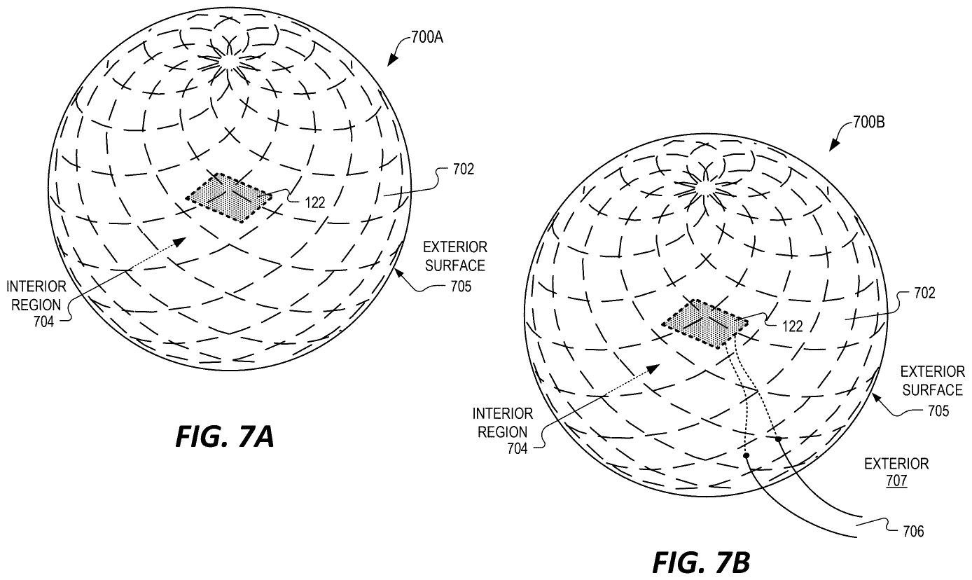

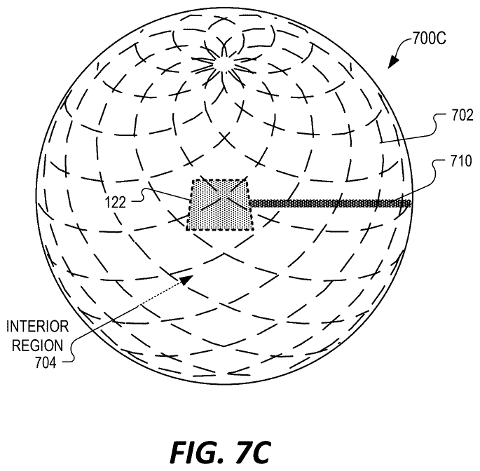

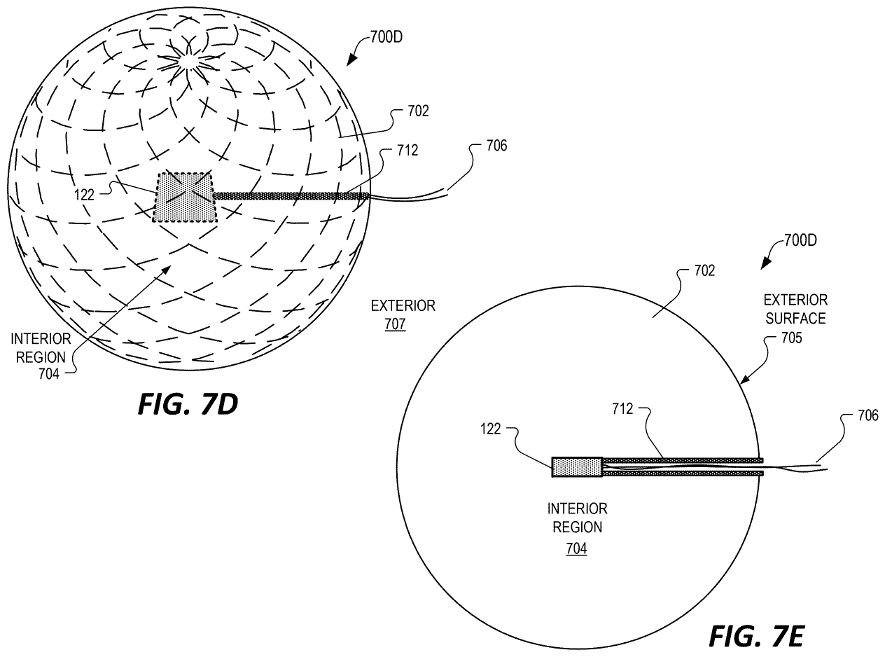

FIG. 7A illustrates an example solid-cryogen encapsulated device 700A, in accordance with aspects of the present disclosure. Solid-cryogen encapsulated device 700A is one possible implementation of solid-cryogen encapsulated device 130 of FIG. 1. Solid-cryogen encapsulated device 700A is shown as including device 122 encapsulated within an interior region 704 of a solid cryogen 702. In some examples, solid cryogen 702 is solid (i.e., frozen) nitrogen. In some aspects, encapsulating the device 122 within the solid cryogen 702 includes embedding or completely surrounding the device 122 with the solid cryogen 702, such that the exterior surfaces of the device 122 are in direct contact with the solid cryogen 702. The exterior surface 705 of the solid-cryogen encapsulated device 700A may have a continuously-curved shape that is absent any edges. For example, exterior surface 705 may have a spherical shape. In addition, in some examples, the solid cryogen 702 is continuous (absent any voids) from the device 122 on the interior region 704 to the exterior surface 705. In another aspect, device 122 is positioned at or near a center of the solid cryogen 702 to provide the same or similar thickness of solid cryogen 702 surrounding the device 122 on all sides.

FIG. 7B illustrates an example solid-cryogen encapsulated device 700B having wires 706, in accordance with aspects of the present disclosure. Solid-cryogen encapsulated device 700B is one possible implementation of solid-cryogen encapsulated device 130 of FIG. 1.

As mentioned above, device 122 may be an electronic device that, after encapsulation, is to be connected/incorporated into a device platform. Thus, as shown in FIG. 7B, device 122 may include one or more wires 706. Wires 706 may include power, ground, data, leads, or other communication wires for connecting device 122 to a device platform. As shown in FIG. 7B, wires 706 are connected to device 122 within the interior region 704 of the solid cryogen 702, and extend through the solid cryogen 702, through the exterior surface 705 to the exterior 707 of the solid-cryogen encapsulated device 700B.

FIG. 7C illustrates an example solid-cryogen encapsulated device 700C having a device mount 710, in accordance with aspects of the present disclosure. Solid-cryogen encapsulated device 700C is one possible implementation of solid-cryogen encapsulated device 130 of FIG. 1. As mentioned above, in some examples, a mold structure (e.g., mold structure 120 of FIG. 1) may include a device mount 710 to suspend the device 122 within the interior cavity of the mold structure as the mold structure is filled with liquid cryogen, which is then frozen.

Device mount 710 is one possible example of device mount 512 of FIG. 5C. In some examples, the device mount 710 may remain embedded within the solid cryogen 702 of the interior region 704 as shown in FIG. 7C. In some aspects, device mount 512 comprises (and is formed from) a ceramic material. However, in other examples, device mount 512 may include any electronic circuit mount materials that are thermally compatible with the device 122 and solid cryogen.

FIGS. 7D and 7E illustrate an example solid-cryogen encapsulated device 700D having a device mount 712, in accordance with aspects of the present disclosure. Solid-cryogen encapsulated device 700D is one possible implementation of solid-cryogen encapsulated device 130 of FIG. 1. In some aspects, device mount 712 is configured to suspend the device 122 within the interior cavity of the mold structure as the liquid cryogen is frozen into solid cryogen 702. In addition, device mount 712 may also be configured to route one or more of the wires 706. As shown in the FIG. 7D, the device mount 712 is disposed to route the wires 706 from the device 122 on the interior region 704 to the exterior 706 of the solid-cryogen encapsulated device 700D. In some examples, device mount 712 may be configured to house and/or protect the one or more wires 706. For instance, as shown in FIG. 7E, device mount 712 may be a tube or conduit through which the one or more wires 706 are housed. In some aspects, during generation of the solid-cryogen encapsulated device, the device mount 712 is configured to route the one or more wires 706 from the device 122 to a wire port of the mold structure (e.g., wire port 524 of FIG. 5F).

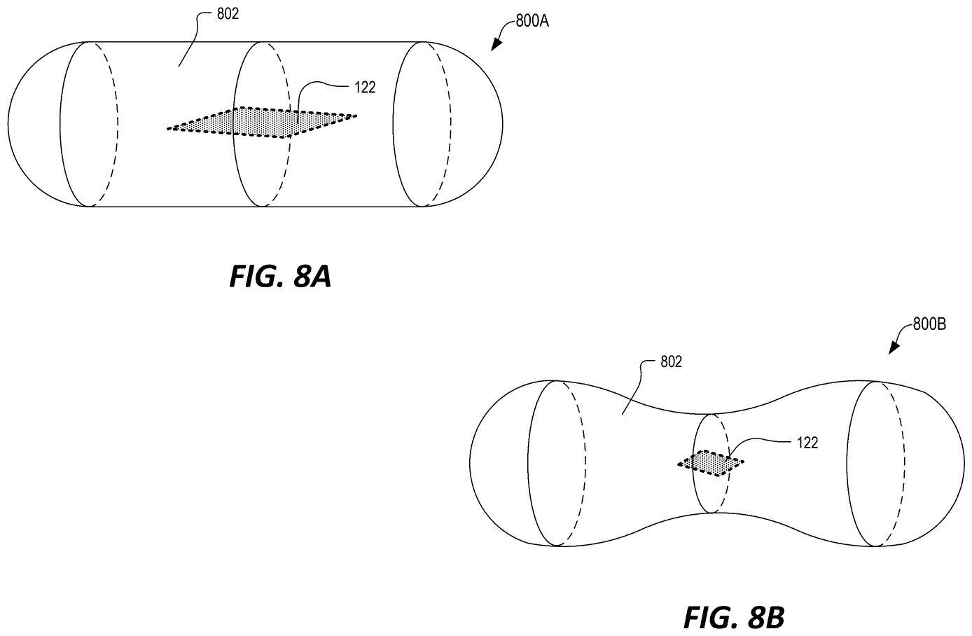

As mentioned above, the shape of the interior cavity of a mold structure (e.g., interior cavity 124 of mold structure 120 of FIG. 1) defines the shape of the resultant solid-cryogen encapsulated device. Aspects of the present disclosure may provide for mold structures that include an interior cavity of a variety of shapes and sizes. In some implementations, the size and shape of the device 122 that is to be cooled may determine the appropriate size and shape of the interior cavity of the mold structure. For example, device 122 may be have a rectangular shape (e.g., longer than it is tall and wide). Accordingly, FIG. 8A illustrates an example solid-cryogen encapsulated device 800A having a solid cryogen 802 formed into a capsule shape that may provide a more uniform cooling for the rectangular-shaped device 122 of FIG. 8A.

In another example, particular cooling requirements of device 122 may dictate the size and shape of the interior cavity. For example, device 122 may require more cooling and/or cooling for longer periods of time near the ends of the device 122. Accordingly, FIG. 8B illustrates an example solid-cryogen encapsulated device 800B having the solid cryogen 802 formed into peanut shape that provides additional cooling for a longer time, near the side edges of device 122.

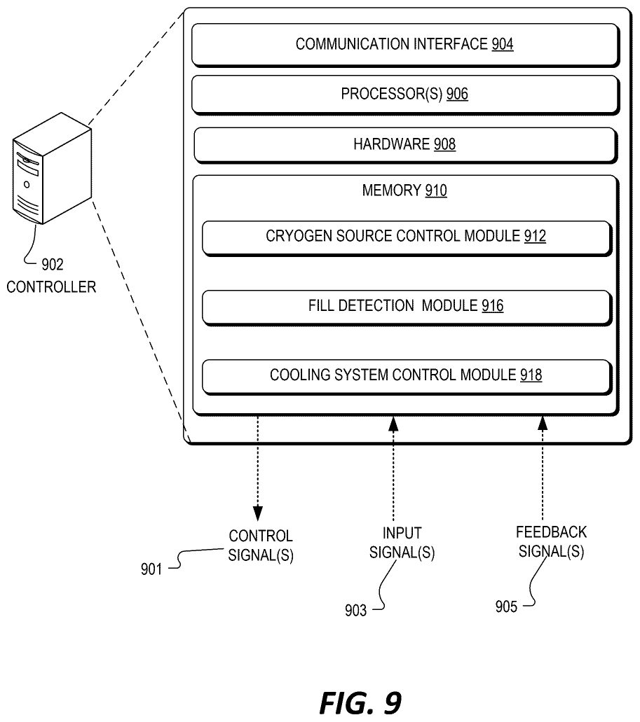

FIG. 9 illustrates an example controller 902 for use with a solid-cryogen encapsulation system, in accordance with aspects of the present disclosure. Controller 902 is one possible implementation of controller 110 of FIG. 1. Controller 902 is shown as including a communication interface 904, a processor 906, hardware 908, and a memory 910

The communication interface 904 may include wireless and/or wired communication components that enable the controller 902 to transmit data to and receive data from other networked devices. This communication may involve, for example, sending and receiving messages, parameters, or other types of information on a network. The hardware 908 may include additional hardware interfaces, data communication, or data storage hardware. For example, the hardware interfaces may include a data output device (e.g., electronic display, audio speakers), and one or more data input devices (e.g., keypads, keyboards, mouse devices, touch screens, microphones, etc.).

The processor 206 of controller 902 may execute instructions and perform tasks under the direction of software components that are stored in memory 910. For example, the memory 910 may store various software components that are executable or accessible by the one or more processors 906 of the controller 902. The various components may include a cryogen source control module 912, a fill detection module 916, and a cooling system control module 918.

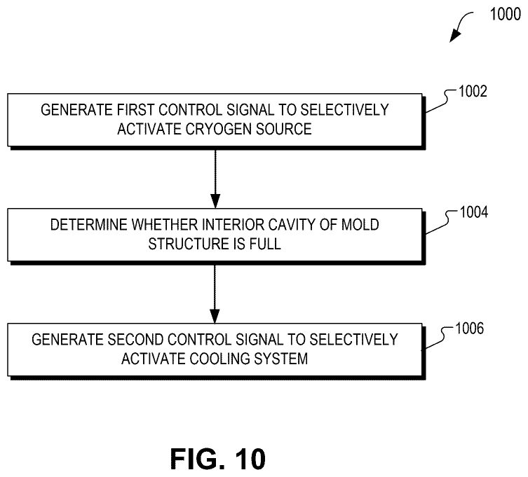

The cryogen source control module 912, the fill detection module 916, and the cooling system control module 918 may include routines, program instructions, objects, and/or data structures that perform particular tasks or implement particular abstract data types. For example, the cryogen source control module 912 may include one or more instructions, which when executed by the one or more processors 906 direct the controller 902 to generate one or more control signals 901 to control the operation of a cryogen source (e.g., cryogen source 102). For example, cryogen source control module 912 may cause controller 902 to generate control signals 901 (e.g., corresponding to control signals 212 of FIG. 2) to perform operations related to starting and stopping the extraction of liquid cryogen from air and/or the starting and stopping of pumping liquid cryogen to the container 104 to fill an interior cavity of a mold structure (e.g., interior cavity 124 of FIG. 1). Similarly, fill detection module 916 may direct the controller 902 to determine whether the interior cavity of the mold structure is full of the liquid cryogen (e.g., interior cavity 124 of FIG. 1). In some examples, fill detection module 916 may receive one or more feedback signals 905 (e.g., corresponding to fill signal 521 of FIG. 5E) indicating whether the interior cavity of the mold structure is full. In another aspect, cooling system control module 918 may cause controller 902 to generate control signals 901 (e.g., corresponding to control signals 312 of FIG. 3) to perform operations related to starting and stopping the cooling system 106 to freeze the liquid cryogen within the interior cavity of a mold structure into a solid cryogen. Further details regarding the operation of controller 902 will be described below with reference to process 1000 of FIG. 10.

In particular, FIG. 10 is a flow diagram of a process 1000 of generating a solid-cryogen encapsulated device, such as the solid-cryogen encapsulated device 130 of FIG. 1. Process 1000 is one possible process performed by controller 110 of FIG. 1 and/or controller 902 of FIG. 9. Process 1000 will be described with reference to, at least, FIGS. 1, 2, 9, and 10.

In some aspects, process 1000 begins after a user has provided a mold structure having a device suspended within the interior cavity of the mold structure. For example, referring to FIG. 1, the user may place mold structure 120 (with suspended device 122) within the freezing compartment 112 of container 104. In some examples, placing the mold structure 120 within the freezing compartment 112 includes connecting to or otherwise positioning the mold structure 120 near the conduit 118, such that the mold structure 120 may receive the liquid cryogen. Next, the cover 116 is placed to close the opening 114 and to seal the freezing compartment 112. In some aspects, closing the opening 114 to seal the freezing compartment 112 may include securing one or more bolts of the container 104 (e.g., see bolts 420 of FIG. 4). Controller 902 may then receive user input (e.g., input signal 903 of FIG. 9) triggering the beginning of process 1000.

Referring to FIG. 10, in a process block 1002, the cryogen source control module 912 generates a first control signal 901 to activate the cryogen source 102 to pump liquid cryogen to the freezing compartment 112 and into the interior cavity 124 of the mold structure 120. Next, in a process block 1004, the fill detection module 916 determines whether the interior cavity 124 of the mold structure 120 is full. As mentioned above, in some examples, the mold structure 120 includes at least one fill sensor that is communicatively coupled to the controller 902 (e.g., by way of communication interface 904 and/or hardware 908). Thus, determining whether the interior cavity of the mold structure is full may include receiving one or more feedback signals 905 from the fill sensor. In other examples, fill detection module 916 may determine whether the interior cavity 124 is full of the liquid cryogen based on a size, shape, or volume of the interior cavity 124. For instance, in some instances, controller 902 may receive an indication via input signal 903 as to the size, shape, or volume of the interior cavity 124. In some aspects, the user may input one or more known parameters (via a user interface) pertaining to the particular mold structure 120 that was placed inside the freezing compartment 112. During the filling of the interior cavity 124 with the liquid cryogen, the fill detection module 916 may also receive feedback signals 905 indicating how much liquid cryogen has been dispensed into the interior cavity 124 (e.g., via one or more flow meters included in cryogen source 102, connector 126, and or conduit 118). Fill detection module 916 then compares the amount of liquid cryogen dispensed with the received indication of the interior cavity's volume, size, or shape to determine when the interior cavity 124 is full. In yet another embodiment, cryogen source 102 may have a known flow rate for providing liquid cryogen. Thus, in this example, the fill detection module 916 may determine whether the interior cavity 124 is full based on an elapsed time that the cryogen source 102 has been pumping the liquid cryogen into the interior cavity 124.

Next, in process block 1006, the cooling system control module 918 generates a second control signal (e.g., control signal 901) to selectively activate the cooling system 106. In some aspects, activating the cooling system 106 draws a vacuum on the freezing compartment 112 which causes the freezing of the liquid cryogen within the interior cavity 124. In general, as the cooling system 106 removes air from the freezing compartment 112, the pressure around the liquid cryogen decreases, causing the cryogen to evaporate more rapidly. This evaporation process absorbs heat from the remaining liquid cryogen, causing its temperature to drop. As the temperature of the liquid cryogen continues to drop, the liquid approaches its freezing point. Once the temperature drops below the freezing point of the cryogen (e.g., −210° C. or 63K for Nitrogen), the cryogen will begin to solidify into solid cryogen 132. In some examples, the solid cryogen 132 is configured to cool and maintain the device 122 to a cryogenic temperature that is approximately 40 Kelvin. In this example, the liquid cryogen provided by the cryogen source 102 may be a mixture of one or more distinct liquid cryogens that, when combined, have a freezing point of around 40 Kelvin.

The processes, methods, functions, or modules explained above may be implemented in hardware, software, firmware, or any combination thereof. If implemented in software, the techniques may be stored on or transmitted as one or more instructions or code on a computer-readable medium. The techniques described may constitute computer-executable instructions embodied or stored within a tangible or non-transitory computer-readable medium, that when executed by a processor will cause the processor to perform the operations or acts described. Additionally, the processes may be embodied within hardware, such as an application specific integrated circuit (“ASIC”) or otherwise.

A tangible non-transitory computer-readable medium includes any mechanism that provides (i.e., stores) information in a form accessible by a machine (e.g., a computer, network device, personal digital assistant, manufacturing tool, any device with a set of one or more processors, etc.). For example, a machine-readable medium may include recordable or non-recordable media (e.g., read only memory (ROM), random access memory (RAM), magnetic disk storage media, optical storage media, flash memory devices, etc.).

In addition, the methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A solid-cryogen encapsulation system, the system comprising:
a cryogen source configured to supply a liquid cryogen;
a container coupled to the cryogen source to receive the liquid cryogen, wherein the container includes:
a freezing compartment having an opening, wherein the freezing compartment is configured to temporarily receive a mold structure through the opening, where the mold structure includes a device suspended within an interior cavity of the mold structure;
a cover configured to selectively close the opening and seal the freezing compartment; and
a conduit disposed within the freezing compartment to fill the interior cavity of the mold structure and submerge the device with the liquid cryogen; and
a cooling system coupled to the container to freeze the liquid cryogen within the interior cavity of the mold structure and encapsulate the device in a solid cryogen.

2. The system of claim 1, wherein the cryogen source comprises:
a liquid cryogen generator configured to extract a cryogen from air to produce the liquid cryogen;
a liquid cryogen storage coupled to receive and store the liquid cryogen produced by the liquid cryogen generator;
a liquid cryogen pump coupled to the liquid cryogen storage to transfer the liquid cryogen from the liquid cryogen storage to the container; and
one or more valves coupled between the liquid cryogen pump and the container to control a flow of the liquid cryogen.

3. The system of claim 1, wherein the cooling system comprises a vacuum pump coupled to the container to evacuate the freezing compartment to a vacuum or a near vacuum.

4. The system of claim 1, further comprising the mold structure, wherein the interior cavity of the mold structure defines a shape for the solid cryogen that is continuously-curved and is absent any edges.

5. The system of claim 1, wherein the container further comprises:
an exterior wall; and
an interior wall that defines the freezing compartment, wherein the interior wall and the exterior wall are separated by a vacuum or near-vacuum insulated region that is between the interior wall and the exterior wall.

6. The system of claim 5, wherein the conduit is coupled to the interior wall.

7. The system of claim 6, wherein the conduit comprises a hose or pipe that is configured to selectively connect to the mold structure to fill the interior cavity of the mold structure with the liquid cryogen.

8. The system of claim 6, wherein mold structure further comprises a channel that directs the liquid cryogen into the interior cavity and wherein the conduit comprises a spout configured to dispense the liquid cryogen into the channel.

9. The system of claim 6, further comprising the mold structure, wherein the mold structure comprises:
a first die;
a second die, that when mated with the first die defines the interior cavity of the mold structure;
a device mount disposed within the interior cavity and configured to receive and suspend the device within the interior cavity;
an inlet port disposed on one of the first die or the second die, wherein the inlet port is configured to receive the liquid cryogen from the conduit and to direct the liquid cryogen into the interior cavity to submerge the device; and
an outlet port disposed on one of the first die or the second die, wherein the outlet port is configured to vent cryogen gas as at least some of the liquid cryogen evaporates during the freezing of the liquid cryogen into the solid cryogen that encapsulates the device.

10. The system of claim 6, wherein the cryogen source, the container, and the cooling system are integrated together into a single portable system that further includes:
a self-contained power source coupled to supply power to the cryogen source and the cooling system, wherein the self-contained power source comprises at least one of a battery or a solar power generator.

11. The system of claim 1, further comprising:
a controller coupled to the cryogen source and to the cooling system, wherein the controller includes:
at least one processor; and
at least one memory coupled to the at least one processor, the at least one memory having instructions stored therein, which when executed by the at least one processor, direct the controller to:
generate a first control signal to selectively activate the cryogen source to pump the liquid cryogen into the interior cavity of the mold structure;
determine whether the interior cavity of the mold structure is full; and
generate a second control signal to selectively activate the cooling system to freeze the liquid cryogen within the interior cavity of the mold structure.

12. The system of claim 11, wherein the mold structure further comprises at least one fill sensor communicatively coupled to the controller, wherein the instructions to determine whether the interior cavity of the mold structure is full further comprises instructions to direct the controller to:
receive one or more signals from the at least one fill sensor indicating that the interior cavity of the mold structure is full of the liquid cryogen.

13. The system of claim 11, wherein the at least one memory further comprises instructions, which when executed by the at least one processor, direct the controller to:
receive, at the controller, an indication of at least one of a size of the interior cavity, a shape of the interior cavity, or a volume of the interior cavity, wherein the instructions to determine whether the interior cavity is full includes instructions to compare an amount of liquid cryogen dispensed into the interior cavity with the received indication.

14. The system of claim 1, wherein the liquid cryogen is liquid nitrogen (LN2).

15. (canceled)

16. The system of claim 9, further comprising:
at least one fill sensor disposed on one of the first die or the second die, and to be communicatively coupled to the solid-cryogen encapsulation system, wherein the at least one fill sensor is configured to generate one or more signals indicating that the interior cavity of the mold structure is full of the liquid cryogen.

17. The system of claim 9, wherein the device is an electronic device that includes one or more wires, and wherein the mold structure further comprises:
a wire port included in at least one of the first die or the second die, wherein the wire port is configured to pass the one or more wires of the device from the interior cavity of the mold structure to an exterior of the mold structure while the device is suspended within the interior cavity.

18. The system of claim 17, wherein the device mount is configured to route the one or more wires from the device to the wire port.

19. The system of claim 9, wherein the interior cavity is one of a plurality of interior cavities and the device is one of a plurality of devices, wherein each interior cavity of the plurality of cavities is configured to receive and have suspended within, a respective one of the plurality of devices, wherein at least one of the first die or the second die includes:
an exterior surface; and
a channel embedded onto the exterior surface, wherein the channel is configured to receive and direct the liquid cryogen to each of the plurality of interior cavities.

20. (canceled)
